(19) United States
(12) Patent Application Publication
(10) Pub. No.: US 2009/0127984 A1
(43) Pub. Date: May 21, 2009

(54) Motor magnetic pre-stressing apparatus

(76) Inventors: Zhen-Yu Lee, Tainan City (TW); Wen-Pin Chen, Tainan City (TW); Jen-Chieh Chang, Kaohsiung City (TW); Sheng-Pin Su, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/984,712

(22) Filed: Nov. 21, 2007

(51) Int. Cl. H02K 7/14; H02K 1/12; H02K 1/27

(52) U.S. Cl. 310/67 R; 310/156.49; 310/91

(57) ABSTRACT

A motor magnetic pre-stressing apparatus includes a stator and a rotor. The rotor is pivoted with the stator. The stator includes a lower insulating frame and a magnetic-guiding ring, and the magnetic-guiding ring is installed on the lower insulating frame. The rotor has a magnetic element, and the magnetic element has even radial magnetic poles. Thereby, by utilizing the attraction between magnetic-guiding ring and the magnetic element, a magnetic pre-stressing force is generated to absorb the rotor downwards so that the rotor rotates stably and smoothly.

### BACKGROUND OF THE INVENTION

1. Field of the Invention

The present invention relates to a motor magnetic pre-stressing apparatus. In particular, this invention relates to a motor magnetic pre-stressing apparatus that can make the rotor and the stator of a radial air gaped motor attract each other. Thereby, the rotor of the motor operates stably and smoothly.

2. Description of the Related Art

Electronic devices have developed rapidly in present times. In order to make the electronic devices become smaller, slimmer and lighter, whilst still keeping users' multiple functions request, the width of the circuit and the distance between the circuits in the device has gradually been shortened. When the electronic device is operating at the same power level or a larger power level, heat generated from the circuit of the electronic device, such as the processor, increases. Cooling becomes an urgent problem. Usually, a fan is used for forming a forced convection to exhaust the heat. Although the exhaustion of the heat can be enhanced by increasing the output power of the fan; however noise and vibration generated by the motor will negatively affect the electronic device, thereby shortening the reliability life of the electronic device.

In order to fit the operational characteristics of a motor for a cooling fan and maintain operational stability of the motor, a proper pre-stressing force is obtained to the rotor of the motor. The pre-stressing force can either be an elastic force or a magnetic pre-stressing force. When the motor structure is not a ball bearing structure type, a magnetic pre-stressing apparatus is the best solution to generate the magnetic pre-stressing force. However, the magnetic pre-stressing apparatus of the prior art reduces the quantity of silicon steel flakes or the equivalent height of the permanent magnet to achieve the magnetic declining effect. Utilizing this method, the output power of the motor is enormously reduced. Alternatively, a motor structure for reducing passive torque of a prior art uses a ring portion. The ring portion and the silicon steel flakes are staggered. The invention generates a stable magnetic pre-stressing force between the rotor and the stator of the motor. Alternatively, it enlarges the passive torque to increase the rotating vibration of the motor. A fan motor with magnetic-guiding flake of a prior art utilizes a magnetic-guiding flake to combine with the circuit board of the motor base. Through holes are added on the circuit board so that the space available on the circuit board for disposing the electronic components is limited. A short circuit may occur between the magnetic-guiding flake and the circuit board. Furthermore, the connecting pin or the wedged portion of the magnetic-guiding flake has to be bent. The manufacturing process is difficult and the manufacturing cost is high.

### SUMMARY OF THE INVENTION

One particular aspect of the present invention is to provide a motor magnetic pre-stressing apparatus. When the rotor of the motor is operating, the amount of vibrations and noise can be reduced. The motor operates stably and smoothly, and the output power of the motor will not need to be wasted.

Another particular aspect of the present invention is to provide a motor magnetic pre-stressing apparatus. A magnetic-guiding ring is installed on the lower insulated frame. Through holes do not need to be added on the circuit board of the motor. The space available on the circuit board is increased, and the manufacturing process is much easier.

The motor magnetic pre-stressing apparatus includes a stator having a lower insulated frame and a magnetic-guiding ring, and a rotor having a magnetic element. The magnetic-guiding ring is installed on the lower insulated frame. The rotor is pivoted with the stator. The magnetic element and the magnetic-guiding ring attract each other.

The present invention has the following characteristics. The lower insulated frame of the stator is installed with the magnetic-guiding ring to ensure the magnetic-guiding ring and the magnetic element of the rotor attract each other. Thereby, a magnetic pre-stressing force is generated to the rotor so that the rotor rotates stably and smoothly. Vibrations and noise are reduced, and the output power of the motor will not need to be lowered. The magnetic-guiding ring merely needs to be installed on the lower insulating frame. Through holes do not need to be added on the circuit board of the motor. The available space on the circuit board is increased, and the manufacturing process is easy.

For further understanding of the invention, reference is made to the following detailed description illustrating the embodiments and examples of the invention. The description is only for illustrating the invention and is not intended to be considered limitation of the scope of the claim.

### BRIEF DESCRIPTION OF THE DRAWINGS

The drawings included herein provide a further understanding of the invention. A brief introduction of the drawings is as follows:

FIG. 1 is an exploded perspective view of the motor magnetic pre-stressing apparatus of the present invention; and

FIG. 2 is an assembly perspective view of the magnetic-guiding ring installed on the lower insulating frame of the stator of the motor magnetic pre-stressing apparatus of the present invention.

### DETAILED DESCRIPTION OF THE PREFERRED EMBODIMENTS

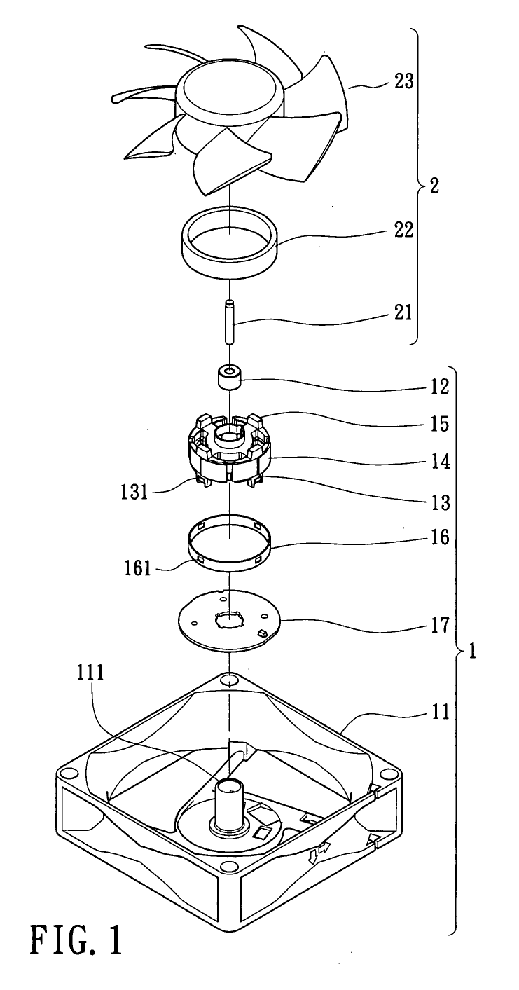

Reference is made to FIG. 1. The motor magnetic pre-stressing apparatus includes a stator 1 and a rotor 2. The stator 1 includes a base 11, a bearing 12, a lower insulating frame 13, a set of silicon steel flakes 14, an upper insulating frame 15, a set of coils (not shown in the figure), a magnetic-guiding ring 16, and a circuit board 17. The base 11 has a bearing base 111. The bearing base 111 extends from the center of the base 11, and the bearing 12 is installed in the bearing base 111.

The outer edge of the lower insulating frame 13 has a plurality of convex portions 131. The convex portions 131 and the lower insulating frame 13 are formed by a natural mold drawing method. The lower insulating frame 13, the set of silicon steel flakes 14, and the upper insulating frame 15 correspond to each other so that set of silicon steel flakes 14 is clipped between the lower insulating frame 13 and the upper insulating frame 15. The set of coils are wrapped around the lower insulating frame 13, the set of silicon steel flakes 14, and the upper insulating frame 15.

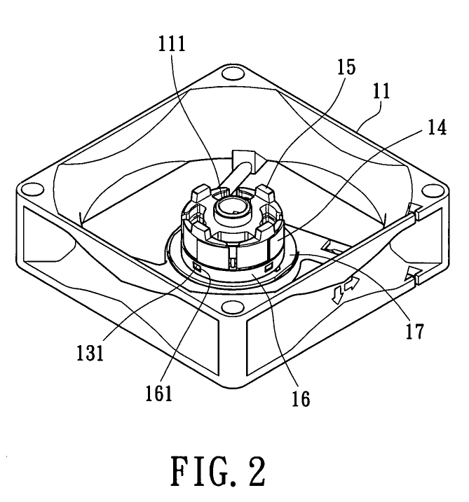

The magnetic-guiding ring 16 is made of iron or silicon steel, and is formed by a punching method. A plurality of punching holes 161 is formed on the magnetic-guiding ring 16. As shown in FIG. 2, the convex portions 131 of the lower insulating frame 13 aligns and wedge with the plurality of punching holes 161 of the magnetic-guiding ring 16 to install the magnetic-guiding ring 16 on the outer edge of the lower insulating frame 13. Next, the circuit board 17 is combined with the lower insulating frame 13 to electrically connect the set of coils with the circuit board 17. Finally, the lower insulating frame 13, the set of silicon steel flakes 14, the upper insulating frame 15, the set of coils, and the circuit board 17 that have been combined together are sleeved on the outer edge of the bearing base 111 of the base 11, and fastened on the base 11.

The rotor 2 includes a rotating shaft 21, a magnetic element 22, and a set of fan blades 23. The magnetic element 22 has even radial magnetic poles (not shown in the figure) made of permanent magnets. The magnetic element 22 is installed in the set of fan blades 23. The rotating shaft 21 is connected with the inner shaft center of the set of fan blades 23. The rotor 2 is pivoted with the stator 1 by plugging the rotating shaft 2 into the bearing 12.

The present invention installs the magnetic-guiding ring 16 on the lower insulating frame 13 to attract the magnetic-guiding ring 16 and the magnetic element 22 to each other. Thereby, a magnetic pre-stressing force is provided to the rotor 2 so that the rotor 2 rotates stably and smoothly, and vibrations and noise are reduced when the motor is operating. By utilizing the magnetic pre-stressing apparatus of the present invention, the quantity of the silicon steel flakes of the set of silicon steel flakes 14 or the equivalent height of the permanent magnet of the magnetic element 22 do not need to be lowered so that output power of the motor is maintained. Alternatively, in order to prevent the rising of the motor temperature, a specific bearing (such as a dynamic pressure bearing, a multiple self-oiling bearings is applied to the fan to lengthen the usage life of the motor of the fan. The magnetic-guiding ring 16 is formed by a punching method. The manufacturing process is easy. A wedged process for wedging the magnetic-guiding ring 16 with the lower insulating frame 13 is added to the original assembling process. Through holes do not need to be added on the circuit board 17 and the available space on the circuit board is increased. The manufacturing cost is reduced to increase the product's competitive advantage.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A motor magnetic pre-stressing apparatus, comprising:
a stator having a lower insulating frame and a magnetic-guiding ring, wherein the magnetic-guiding ring is installed on the lower insulating frame; and
a rotor having a magnetic element, wherein the rotor is pivoted with the stator, and the magnetic element and the magnetic-guiding ring attract each other.

2. The motor magnetic pre-stressing apparatus as claimed in claim 1, wherein an outer edge of the lower insulating frame has a plurality of convex portions, the magnetic-guiding ring has a plurality of punching holes, and the convex portions correspond to and wedge with the punching holes.

3. The motor magnetic pre-stressing apparatus as claimed in claim 1, wherein the magnetic-guiding ring is installed on an outer edge of the lower insulating frame.

4. The motor magnetic pre-stressing apparatus as claimed in claim 1, wherein the magnetic-guiding ring is made of iron or silicon steel.

5. The motor magnetic pre-stressing apparatus as claimed in claim 1, wherein the stator includes a set of silicon steel flakes, an upper insulating frame, and a set of coils, the set of silicon steel flakes is clipped between the lower insulating frame and the upper insulating frame, and the set of coils wraps around the lower insulating frame, the set of silicon steel flakes, and the upper insulating frame.

6. The motor magnetic pre-stressing apparatus as claimed in claim 1, wherein the stator includes a base, the base has a bearing base, the bearing base extends from a center of the base, and the lower insulating frame is sleeved on an outer edge of the bearing base and installed on the base.

7. The motor magnetic pre-stressing apparatus as claimed in claim 6, wherein the base has a circuit board.

8. The motor magnetic pre-stressing apparatus as claimed in claim 1, wherein the rotor has a set of fan blades, and the magnetic element is installed on the set of fan blades.

9. The motor magnetic pre-stressing apparatus as claimed in claim 1, wherein the magnetic element has even radial magnetic poles.

10. The motor magnetic pre-stressing apparatus as claimed in claim 9, wherein the radial magnetic poles are made of permanent magnets.
